(19) United States
(12) Patent Application Publication
(10) Pub. No.: US 2009/0234475 A1
(43) Pub. Date: Sep. 17, 2009

(54) PROCESS FOR MANAGING DIGITAL AUDIO STREAMS

(75) Inventors: Owen Nicolas Marie LAGADEC, Anglet (FR); Fabien Paul Andre GALLOT, Biarritz (FR); Ivan DUCHEMIN, Bidart (FR); Myriam DESAINTE-CATHERINE, Talence (FR); Sylvain MARCHAND, Pessac (FR)

Correspondence Address: YOUNG & THOMPSON, 209 Madison Street, Suite 500, ALEXANDRIA, VA, 22314, US

(73) Assignees: IKLAX MEDIA, Bidart (FR); UNIVERSITE DE BORDEAUX 1, Talence (FR); CENTRE NATIONAL DE LA RECHERCHE SCIENTIFIQUE, Paris (FR)

(21) Appl. No.: 12/186,550

(22) Filed: Aug. 6, 2008

(30) Foreign Application Priority Data
Mar. 12, 2008 (FR) 08/51618

(51) Int. Cl. G06F 17/00; G06F 3/048

(52) U.S. Cl. 700/94; 715/716

(57) ABSTRACT

The object of the invention is a process for managing digital audio streams, consisting in creating digital audio streams called tracks (p1 to p21), whereby each of said digital audio streams corresponds to a sound signal, characterized in that it consists, at the time of creation, in combining said tracks into at least two units (G1 to G5), whereby the tracks and units are called elements, in establishing constraints on the elements, in verifying that each new constraint is compatible with the prior constraints using a constraint resolution engine, in encapsulating the tracks (p1 to p21) and the constraints in a single computer file, and when the user listens to the work, in selecting the tracks that he wishes to hear in accordance with the constraints, and obtaining a sound signal from the selected tracks.

This invention relates to a process for managing digital audio streams as well as to a digital audio file format.

A musical work and more generally an audio stream can come in the form of a digital file, for example a file of the WAV- or MP3-type, etc. For the remainder of the description, an audio stream in the form of a digital file is called a digital audio stream.

At the time of creation, the creator uses several tracks, each corresponding to one or more instruments and/or voices. During mixing, the creator modifies acoustic characteristics of each track and combines all of the tracks so as to generate a single digital audio stream.

There are numerous documents that deal with mixing although this part is not presented in more detail.

Even if there are aids to carry out this work, the mixing requires technical, artistic and musical expertise to make the digital audio stream audible.

This digital audio stream is then made available to the public recorded on various media, for example on a CD. As a variant, the digital audio stream can come in the form of a computer file that can be uploaded on a computer network. The computer file can have different formats based on the compression software used.

When a user listens to the digital audio stream, the computer file is converted into a sound signal using a reader. According to a known listening method, the listener can adjust the volume, the balance, and using an equalizer, adjust the volume of certain frequency ranges. Consequently, the listener has very little capability of manipulation. Thus, by way of example, it is not possible to remove one or more instruments.

To allow the listener to modify the digital audio stream and to make the act of listening interactive, there are signal processing methods as described in, for example, the document U.S. Pat. No. 5,877,445. In this case, the digital audio stream is cut into successive time segments called blocks. Each of these blocks can be processed so as to modify the corresponding sound signal, for example using computer software. The digital audio stream is reconstituted by using the blocks one after the other.

This technique offers the listener a broad selection of presentation. However, this great latitude most of the time leads to a piece of inaudible music, no longer in accordance with the work of the creator.

If it is sought to obtain a reconstituted audible digital audio stream, it is necessary to process the upstream and downstream edges of each block so that the end of each block can coincide with the beginning of the next block. This signal processing is complex, and the results that are obtained are not generally in accordance with the work of the creator. In addition, this signal processing takes considerable computing time and requires significant computing power, which is not compatible with the majority of listening devices of the listeners.

Also, this invention aims at eliminating the drawbacks of the prior art by proposing a process for managing digital audio streams that make it possible to obtain an interactive and audible listening, not requiring a significant computing time.

For this purpose, the invention has as its object a process for managing digital audio streams, consisting in creating digital audio streams called tracks, each of said digital audio streams corresponding to a sound signal, characterized in that it consists, at the time of creation, in combining said tracks into at least two units, whereby the tracks and units are called elements, in establishing constraints on the elements, in verifying that each new constraint is compatible with the prior constraints using a constraint resolution engine, in encapsulating the tracks and the constraints in a single computer file, and when the user listens to the work, in selecting the tracks that he wishes to hear in accordance with the constraints and obtaining a sound signal from the selected tracks.

Other characteristics and advantages will emerge from the following description of the invention, a description that is provided only by way of example, taking into account the accompanying drawings, in which:

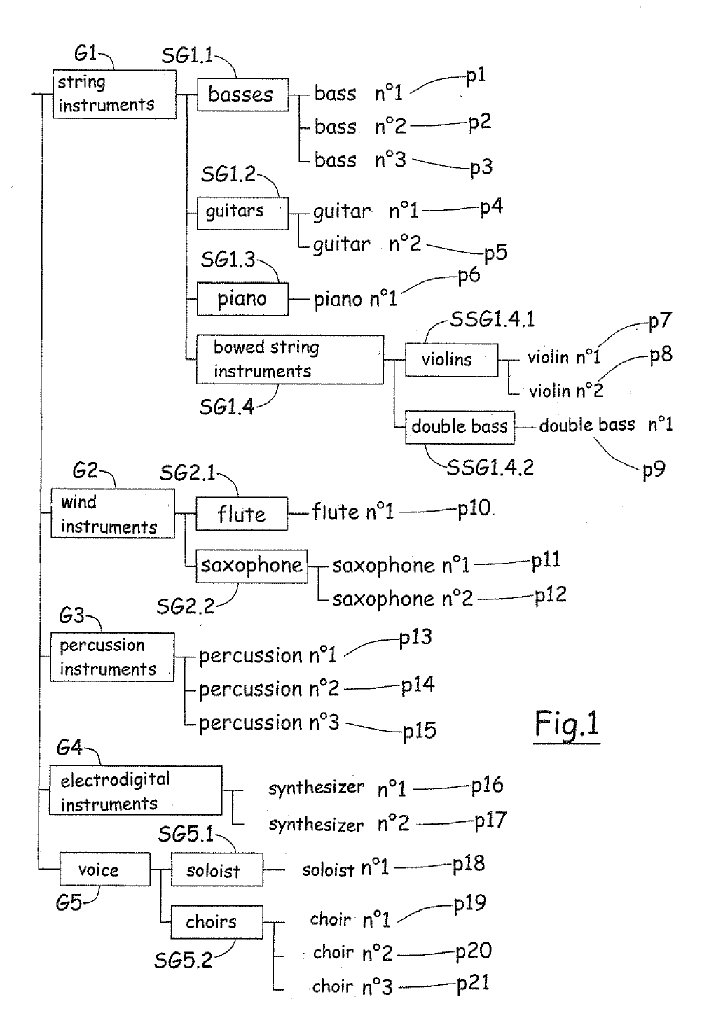

FIG. 1 is a diagram that illustrates the different tracks that can be contained in a musical work,

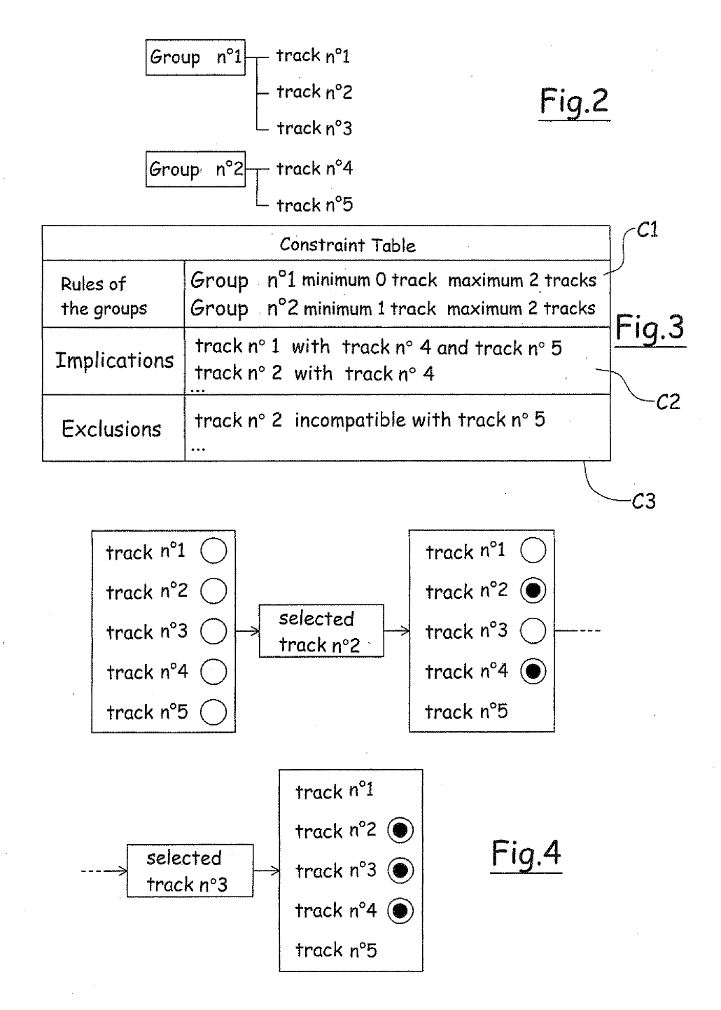

FIG. 2 is a simplified diagram of different groups and tracks of a musical work according to the invention,

FIG. 3 is a table that illustrates an example of constraints applied to the tracks of FIG. 2, and

FIG. 4 is a diagram that illustrates the display of tracks during the selections of the listener prior to listening to the tracks illustrated in FIG. 2.

In FIG. 1, tracks of a musical work are shown from p1 to p21.

Musical work is defined as any musical creation regardless of the type, the form, the duration, . . . .

Track is defined as a sound signal that corresponds to one or more instruments, to one or more voices, or to a mixture of instruments and/or voices. These tracks have a duration that is approximately equal to the musical work. A musical work can comprise n tracks, whereby n is an integer.

In a known way, each track can be arranged according to the creator's wishes.

During the creation, the tracks are combined by the creator into at least two units G. The units may correspond to groups G that can be divided into sub-groups SC that can themselves be divided into sub-sub-groups SSG.

By way of example, as illustrated in FIG. 1, the musical work comprises five groups, referred to as “string instruments” G1, “wind instruments” G2, “percussion instruments” G3, “eleetrodigital instruments” G4, and “voice” G5.

The names of the groups and their numbers are determined by the creator.

According to the example that is illustrated in FIG. 1, the group G1 comprises four sub-groups, referred to as “basses” SG1.1, “guitars” SG1.2, “piano” SG1.3 and “bowed string instruments” SG1.4. The latter is divided into a first sub-sub-group “violins” SSG1.4.1 and a second sub-sub-group “double bass” SSG1.4.2.

The group G2 is divided into two sub-groups “flutes” SG2.1 and “saxophones” SG2.2.

The group G5 is divided into two sub-groups “soloists” SG5.1 and “choirs” SG5.2.

According to the example that is illustrated in FIG. 1, the sub-group SG1.1 comprises the tracks 1 to 3, the sub-group SG1.2 comprises the tracks 4 and 5, the sub-group SG1.3 comprises the track 6, the sub-sub-group SSG1.4.1 comprises the tracks 7 and 8, the sub-sub-group SSG1.4.2 comprises the track 9, the sub-group SG2.1 comprises the track 10, the sub-group SG2.2 comprise the tracks 11 and 12, the group G3 comprises the tracks 13 to 15, the group G4 comprises the tracks 16 and 17, the sub-group SG5.1 comprise the track 18, and the sub-group SG5.2 comprises the tracks 19 to 21.

According to the example that is illustrated in FIG. 1, the tracks are distributed in units along three levels, namely groups, sub-groups and sub-sub-groups. However, the invention is not limited in the number of levels.

For the remainder of the description, the tracks and the units are defined as elements.

After having distributed the tracks into at least two units, the creator defines constraints on at least one element that are listed in a table or register. This phase of the creation is implemented in particular on a computer that is linked to a sound-reproduction system such as speakers.

For the remainder of the description of the invention, the latter is given with regard to a simplified case, illustrated in FIG. 2, comprising two groups G1 and G2 that comprise respectively tracks p1 to p3 for G1 and p4, p5 for G2.

The constraints can be of different types.

According to the first type of constraints c1, the creator can specify—for at least one unit, preferably each unit—minimum and/or maximum numbers of elements of the unit that are played simultaneously. The elements of one given group comprise tracks of the group as well as the groups of the lower level. In the case of a combination of tracks with a number of levels higher than one, the constraints that are linked to the groups of different levels should be consistent.

By way of example, for group 1, the minimum number of elements played simultaneously is 0, and the maximum number is 2. For group 2, the minimum number is 1, and the maximum number is 2.

According to a second type of constraints c2, the creator can specify implications, namely elements that should be played simultaneously. According to the illustrated example, the track p1 should be played simultaneously with the tracks p4 and p5; the track p2 should be played with the track p4.

The implications can apply to elements of the same unit or different units.

The implications can be relative to tracks or to groups of tracks. Thus, the tracks of a first unit (group, sub-group, sub-sub-group) should be played simultaneously with the tracks of a second unit.

According to a third type of constraints c3, the creator can provide exclusions, namely elements that cannot be played simultaneously. Thus, according to the illustrated example, the track p2 is incompatible and should not be played with track p5.

The exclusions can apply to elements of the same unit or of different units.

The exclusions can be relative to tracks or to groups of tracks. Thus, the tracks of a first unit (group, sub-group, sub-sub-group) cannot be played simultaneously with the tracks of a second unit.

Other constraints can be considered, such as, for example, constraints that can be imposed on elements, in particular the mini and maxi volume.

Of course, the constraints that are imposed by the creator should be compatible with one another.

Thus, the process of the invention comprises means that are aimed at testing whether the constraints are compatible. These means are called constraint resolution engine below and will be presented in more detail later.

Preferably, when the creator imposes a new constraint, the process—owing to the constraint resolution engine—tests whether this new constraint is compatible with the prior ones. If so, the new constraint is validated and integrated into the constraint table. In the case of inconsistency, a message informs the creator that this new constraint is not compatible with the prior ones, and it is not integrated into the constraint table.

When the constraint table is completed, the tracks and the constraint table are encapsulated in a single computer file of a new type of format. This computer file can be recorded on all media. As a variant, this computer file can be stored in a database and be uploaded via a computer network.

When it is desired to listen to the musical work, the listener uses a reader that comprises the constraint resolution engine and that makes it possible to extract from the computer file according to the invention the tracks of the musical work and the constraint table. This reader makes it possible to visualize the different tracks, to select them in accordance with the constraints imposed by the creator, and finally to play the selected tracks. According to one embodiment, this reader is of the virtual type and consists of software that makes it possible to visualize the different tracks, to select them in accordance with the constraints that are imposed by the creator, and, finally, to play the selected tracks.

This listening phase is implemented in particular on a computer that is linked to a sound-reproduction system such as speakers.

In addition, the listener can use known means of the prior art such as an equalizer, a balance, an adjustment of the volume, etc., to modify the overall sound signal, the digital audio streams of at least one track and/or at least one group of tracks. These means are not presented in more detail.

Advantageously, the tracks are displayed in accordance with the tree structure defined by the creator.

As illustrated in FIG. 4, the listener can select the tracks that he wishes, for example by checking a box associated with each track.

The selection is performed in accordance with the constraints of the creator. The constraint resolution engine makes it possible to verify whether the selection is possible and to complete the action of the listener.

Thus, by way of example, if the listener checks track no. 2, the constraint resolution engine will check track no. 4, which is necessarily played with track no. 2 and makes it impossible to select track no. 5, which cannot be played with track no. 2.

The listener can stop at this selection and begin the reading. Tracks no. 2 and no. 4 are played simultaneously.

According to another case, the listener can select another track between track no. 1 or no. 3. If track no. 3 is selected, the constraint resolution engine verifies whether this selection is possible. If so, it completes the action of the listener by making it impossible to select track no. 1, whereby a maximum of two tracks of group G1 can be played simultaneously.

If track no. 1 is selected, the constraint resolution engine verifies whether this selection is possible. In this case, the selection of track no. 1 imposes the selection of tracks no. 4 and no. 5. However, track no. 5 cannot be selected with track no. 2, already selected. Consequently, the selection of track no. 1 is impossible. A message is given to the listener indicating to him that his selection is not possible. As a variant, the constraint resolution engine validates the selection of track no. 1 and checks the boxes of tracks no. 1, no. 4 and no. 5 and makes it impossible to select track no. 2.

At the end of his selection, the listener—for each track can adjust the sound signal by adjusting the volume, or the balance or by processing it using an equalizer.

At the end of the parametrizing, the listener begins the reading of the digital audio stream, whereby the selected tracks are played simultaneously so as to obtain a sound signal.

As a variant, when a user is listening, he can change his selection of tracks. The constraint resolution engine makes it possible, in real time, to complete the selection of the listener by adding or eliminating tracks based on constraints.

It is noted that the process for managing digital audio streams according to the invention makes it possible to make the act of listening to a musical work interactive, because the listener can select tracks and thus modify the emitted sound signal. According to another advantage, the process according to the invention does not require a significant computing power because it processes tracks and not blocks that should be played successively, which makes it compatible with the majority of the listening devices. The sound signal that is derived from reading digital audio streams is perfectly audible because the selection of tracks is framed by the constraints imposed by the creator.

The constraint resolution engine is now presented in detail.

During the creation phase, the constraint resolution engine should make it possible to validate the selection of constraints that the creator wishes to impose.

When the creator imposes a new constraint, the constraint resolution engine verifies whether this new constraint is compatible with the constraints already imposed. To perform this control, all of the tracks are put into the same state, preferably in the inactive state. Next, the constraint resolution engine verifies that all of the tracks can change state and that the set of constraints is complied with. If this test is conclusive, the new constraint is compatible with the constraints already imposed and validated in the table of constraints.

If no solution has been found so that all of the tracks change state, then the new constraint is not compatible with the constraints that are already imposed. A message informs the creator that this constraint is not compatible.

During the listening phase, the constraint resolution engine makes it possible to verify whether the selection of the listener is possible and complies with the set of constraints.

If n tracks that are in different active or inactive states define a state combination, the selection of the listener leads to a change of state of the track i (included in the n tracks). The constraint resolution engine verifies that this new combination with this new state of track i is possible and complies with the set of constraints. If so, the change of stage of the track i is validated.

If this combination is not possible, two solutions can be considered.

The first solution consists in noting that this change of state is not possible.

According to a preferred solution, this change of state is automatically validated, but the constraint resolution engine determines—over a given period of time the possible combination that integrates this change of state that is closest to the prior combination. A first combination is called the closest to a second combination if the number of tracks in the active state of the first combination is the closet to the number of tracks in the active state of the second combination.

During the listening phase, the constraint resolution engine makes it possible to update the possible selections after a selection by the listener.

Thus, after having verified that the selection is possible, the constraint resolution engine checks the tracks that are imposed based on this new selection owing to the implications and makes it impossible to select optionally certain tracks based on this new selection owing to the exclusions.

1. Process for managing digital audio streams, consisting in creating digital audio streams called tracks (p1 to p21), whereby each of said digital audio streams corresponds to a sound signal, characterized in that it consists, at the time of creation, in combining said tracks into at least two units (G), whereby the tracks and units are called elements, in establishing constraints (c1 to c3) on the elements, in verifying that each new constraint is compatible with the prior constraints using a constraint resolution engine, in encapsulating the tracks (p1 to p21) and the constraints (c1 to c3) in a single computer file, and when the user listens to the work, in selecting the tracks that he wishes to hear in accordance with the constraints (c1 to c3) and obtaining a sound signal from the selected tracks.

2. Process for managing digital audio streams according to claim 1, wherein it consists in specifying for at least one unit—preferably each unit—the minimum and maximum numbers of elements of the unit played simultaneously.

3. Process for managing digital audio streams according to claim 1, wherein it consists in specifying implications between elements, whereby said linked elements have to be played simultaneously.

4. Process for managing digital audio streams according to claim 1, wherein it consists in specifying exclusions between elements, whereby said linked elements cannot be played simultaneously.

5. Process for managing digital audio streams according to claim 1, wherein when the creator imposes a new constraint, the constraint resolution engine verifies whether this new constraint is compatible with the constraints already imposed.

6. Process for managing digital audio streams according to claim 5, wherein the constraint resolution engine verifies that all of the tracks can change state and that the constraints are complied with.

7. Process for managing digital audio streams according to claim 1, wherein during the listening phase, the constraint resolution engine verifies whether a combination of track states determined by the listener is possible and is in accordance with the set of constraints.

8. Process for managing digital audio streams according to claim 7, wherein if the change of state of a track selected by the listener does not comply with the set of constraints, the change of state of said track is automatically validated and wherein the constraint resolution engine determines—over a given period of time—a possible combination that integrates this change of state that is closest to the combination before this change of state.

9. Process for managing digital audio streams according to claim 1, wherein the constraint resolution engine updates the possible selections after a selection by the listener.

10. Process for managing digital audio streams according to claim 2, wherein it consists in specifying implications between elements, whereby said linked elements have to be played simultaneously.

11. Process for managing digital audio streams according to claim 2, wherein it consists in specifying exclusions between elements, whereby said linked elements cannot be played simultaneously.

12. Process for managing digital audio streams according to claim 2, wherein when the creator imposes a new constraint, the constraint resolution engine verifies whether this new constraint is compatible with the constraints already imposed.

13. Process for managing digital audio streams according to claim 2, wherein during the listening phase, the constraint resolution engine verifies whether a combination of track states determined by the listener is possible and is in accordance with the set of constraints.

14. Process for managing digital audio streams according to claim 2, wherein the constraint resolution engine updates the possible selections after a selection by the listener.
